(19) United States
(12) Patent Application Publication
(10) Pub. No.: US 2020/0103432 A1
(43) Pub. Date: Apr. 2, 2020

(54) SAMPLE EXTRACTION DEVICE

(71) Applicant: ACCUBIOMED CO., LTD, New Taipei City (TW)

(72) Inventors: Hsueh Tse LU, New Taipei City (TW); Chu Kuei LIN, New Taipei City (TW)

(21) Appl. No.: 16/354,393

(22) Filed: Mar. 15, 2019

(30) Foreign Application Priority Data
Sep. 28, 2018 (TW) 107213212

(51) Int. Cl. G01N 35/10; B01L 9/00; B01L 3/00; B01L 3/02

(52) U.S. Cl. CPC G01N 35/1011; G01N 35/109; B01L 9/54; G01N 2035/00346; B01L 3/0293; B01L 3/50857; G01N 2035/1039; B01L 3/523

(57) ABSTRACT

The present invention provides a sample extraction device, comprising an extraction table and an operating and moving module. The operating and moving module comprises a first horizontal movement module, a first vertical movement module, and a suction module. The suction module is provided on a supporting frame of the first horizontal movement module, and comprises a second vertical movement module and an injector, the second vertical movement module is configured to move vertically with respect to the extraction table, the injector has an airtight cylinder and a piston rod, and the airtight cylinder is connected to the gas delivery tube; wherein the second vertical movement module moves vertically to push or pull the airtight cylinder or the piston rod, in order for the injector to generate positive or negative pressure. The sample extraction device of the present invention can reduce the space required for operation substantially.

### BACKGROUND OF THE INVENTION

### 1. Technical Field

The present invention relates to a sample extraction device and more particularly to a machine adapted for use in the biological field to extract hereditary substances from a sample in an automated manner.

### 2. Description of Related Art

Sample extraction used to be a labor-intensive, complicated procedure whereby, due to the limitation of manpower and time, only a limited number of samples could be processed in a single batch. Moreover, errors or contamination caused by manual operation made it difficult to control the quality of the target substances extracted.

With the decoding of hereditary substances and the maturing of nucleic acid extraction techniques, molecular biology has developed rapidly and is now extensively used in such areas as medicine, pharmaceutics, food technology, and forensics, making tremendous impact on human life. Nucleic acids can be extracted in many ways, some common examples of which are the reagent-based extraction and purification method, the magnetic bead-based extraction and purification method, and the column-based extraction and purification method. Currently, column-based extraction and purification is the most widely used because of its relatively simple operation, high recovery rate, and stable performance.

The principle of column-based extraction and purification is briefly stated as follows. To start with, cells are broken open with an anionic detergent to release nucleic acids from inside the cells and denature proteins on the nucleic acids. Then, proteinase K is added to remove the proteins from the nucleic acids, with a view to increasing the yield of nucleic acids. The resulting DNA-containing mixture is injected into a purification column in order for the nucleic acids to bind to the purification membrane in the purification column (which step is generally known as the binding step), and for the other substances (e.g., ions, salts, proteins, and impurities), which do not bind to the purification membrane, to be discharged. The foregoing procedure is repeated several times, with the addition of cleaning fluid and centrifugation to increase the purity of nucleic acids (which step is known as the cleaning step). After that, an eluent of a particular salinity and pH value is used to change the electrical properties of the purification membrane, before another centrifugation is applied to separate nucleic acids from the purification membrane (which step is known as the collection step).

One major feature of column-based extraction and purification is that, by using an adsorptive material specific to nucleic acids and adjusting the adsorption and elution of nucleic acids with an eluent of a particular salinity and pH value, this method can collect and purify the nucleic acids in a sample effectively and is therefore suitable for use where only a limited number of specimens are available.

To enhance the efficiency and quality of extraction, fully automated extraction systems were recently developed. These systems require far less labor than their prior art counterparts, can increase the extraction efficiency of target substances (e.g., nucleic acids) effectively, and feature consistent extraction quality.

### BRIEF SUMMARY OF THE INVENTION

Take nucleic acid extraction for example, fully automated nucleic acid extraction machines on the market are generally so designed that liquids for use in different steps are stored respectively at different locations to cope with the complicated extraction procedure and avoid cross-contamination between samples and steps. For example, the spent liquor tank is located away from where the buffer solution is kept, but the activation buffer is close to the extraction column. To reduce contamination, therefore, an automated nucleic acid extraction machine must have a relatively large plate for receiving the various solutions needed. The plate must also be movable to enable automation of the extraction steps. Consequently, such a machine takes up a lot of space and is too bulky to be placed on a laboratory bench.

In view of the deficiencies and shortcomings of conventional techniques in the art, the primary objective of the present invention is to provide a sample extraction device, comprising: an extraction table comprising: a base having a receiving space; a supporting structure provided on the base, wherein the supporting structure comprises a supporting table and a fixing unit on which the supporting table is placed, the supporting table is provided above and corresponds to the receiving space, and the supporting table comprises a receptacle receiving space; and a collection module provided in the receiving space, wherein the collection module comprises a collection module base for receiving a container; and an operating and moving module comprising: a first horizontal movement module provided on the base and configured to move horizontally with respect to the extraction table, wherein the first horizontal movement module comprises a supporting frame; a first vertical movement module provided on the supporting frame and configured to move vertically with respect to the extraction table, wherein the first vertical movement module comprises a first platform and a second platform provided underneath the first platform, the first platform is penetrated by a spring unit and is connected to the second platform via the spring unit, the first platform is provided with a micropipette holder extending through the second platform, and the micropipette holder has an end which is used for configuring with a micropipette and an opposite end provided with a gas delivery tube; and a suction module provided on the supporting frame, wherein the suction module comprises a second vertical movement module and an injector, the second vertical movement module is configured to move vertically with respect to the extraction table, the injector has an airtight cylinder and a piston rod, and the airtight cylinder is connected to the gas delivery tube; wherein the second vertical movement module moves vertically to push or pull the airtight cylinder or the piston rod, in order for the injector to generate positive or negative pressure.

Further, the collection module comprises: a second horizontal movement module configured to move the collection module base horizontally in the receiving space; a driven member mounted around a bottom portion of the collection module base; and a driving unit provided in the receiving space and in the vicinity of the collection module base; wherein the driving unit moves by the collection module base moving and, in turn, the driving unit pushes the driven member so as to move the collection module base or the containers received in the collection module base.

Further, the collection module base comprises an engaging groove for securing a lid of the container.

Further, the extraction table comprises a heating module provided on the base, and corresponds to the supporting structure.

Further, the second vertical movement module comprises a pushing unit for compressing the spring unit when the second vertical movement module moves downward, in order for the compressed spring unit to move the second platform, and for the micropipette to be removed from the micropipette holder when the second platform, through which the micropipette holder extends, is displaced downward with respect to the micropipette holder.

Further, the receptacle receiving space of the supporting table comprises a space for receiving a cartridge, wherein the cartridge is configured to receive pipettes, binding columns, pipettes with an adapter, or reagents.

Further, the containers in the collection module base correspond in position to the cartridge(s) in the supporting table.

Further, the moving direction of the first horizontal movement module corresponds to the orientation of the receptacle receiving space of the supporting table.

Further, the supporting frame is vertical with respect to the base and has a front side and a rear side opposite the front side; and the first vertical movement module is provided on the front side of the supporting frame, with the suction module provided on the rear side of the supporting frame.

Further, the piston rod is fixed on the supporting frame, and the second vertical movement module is configured to move the airtight cylinder vertically so that the injector generates positive or negative pressure.

Therefore, the sample extraction of the present invention has the following advantages:

1. The present invention provides a sample extraction device whose operating and moving module can move horizontally and vertically with respect to the extraction table so that the sample extraction process can be carried out by displacing the operating and moving module only, without moving the extraction table. This substantially reduces the space required for operation, making the sample extraction device of the present invention suitable for use on a laboratory bench.

2. The second horizontal movement module in the present invention can move the driving unit and the driven member by slightly displacing the collection module base, thereby displacing the containers in the collection module base vertically. This allows the containers to move upward in the target substance collection stage and/or the spent liquor collection stage of an extraction operation, lest the target substances or reagents splash due to the ejection of a liquid and be cross-contaminated as a result.

3. The engaging groove of the collection module base is configured to secure the lids of the aforesaid containers (e.g., centrifuge tubes) so that extraction operations will not be affected by displacement of the containers or rotation of the lids (the lids may block the operation area if not so secured). Thus, the sample extraction device of the present invention can effectively increase the extraction efficiency of target substances (e.g., nucleic acids) and provide consistent extraction quality.

### BRIEF DESCRIPTION OF THE SEVERAL VIEWS OF THE DRAWINGS

FIG. 1 is a perspective view of a preferred embodiment of the present invention;

FIG. 2 shows the rear-side structure of the preferred embodiment in FIG. 1;

FIG. 3 is a perspective view of the extraction table of the preferred embodiment in FIG. 1;

FIG. 4 is a sectional view of the extraction table of the preferred embodiment in FIG. 1;

FIG. 5 shows a state of use of the collection module of the preferred embodiment in FIG. 1;

FIG. 6 shows another state of use of the collection module of the preferred embodiment in FIG. 1;

FIG. 7 is a front view of the preferred embodiment in FIG. 1; and

FIG. 8 shows a state of use of the pushing unit of the preferred embodiment in FIG. 1.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

The use of “or” means “and/or” unless stated otherwise. The use of “comprise” means not excluding the presence or addition of one or more other components, steps, operations, or elements to the described components, steps, operations, or elements, respectively. Similarly, “comprise,” “comprises,” “comprising” “include,” “includes,” and “including” are interchangeable and not intended to be limiting. As used herein and in the appended claims, the singular forms “a,” “an,” and “the” include plural referents unless the context dictates otherwise. The terms “a”, “an,” “the,” “one or more,” and “at least one,” for example, can be used interchangeably herein.

The present invention is more detailed illustrated by the example embodiments as below. While example embodiments are disclosed herein, it should be understood that they are used for illustrating the present invention, not for limiting the scope of the present invention.

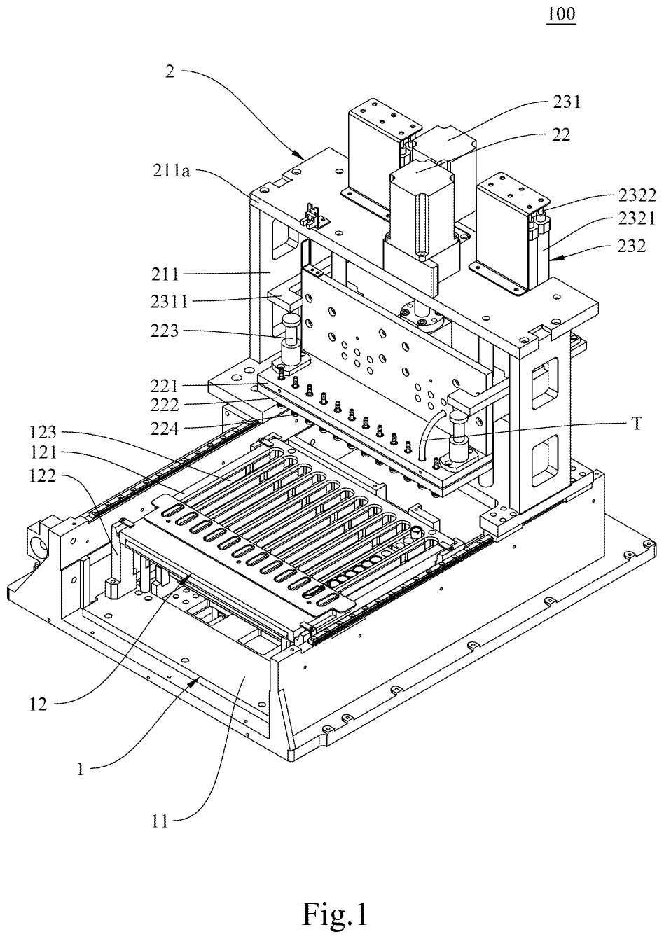

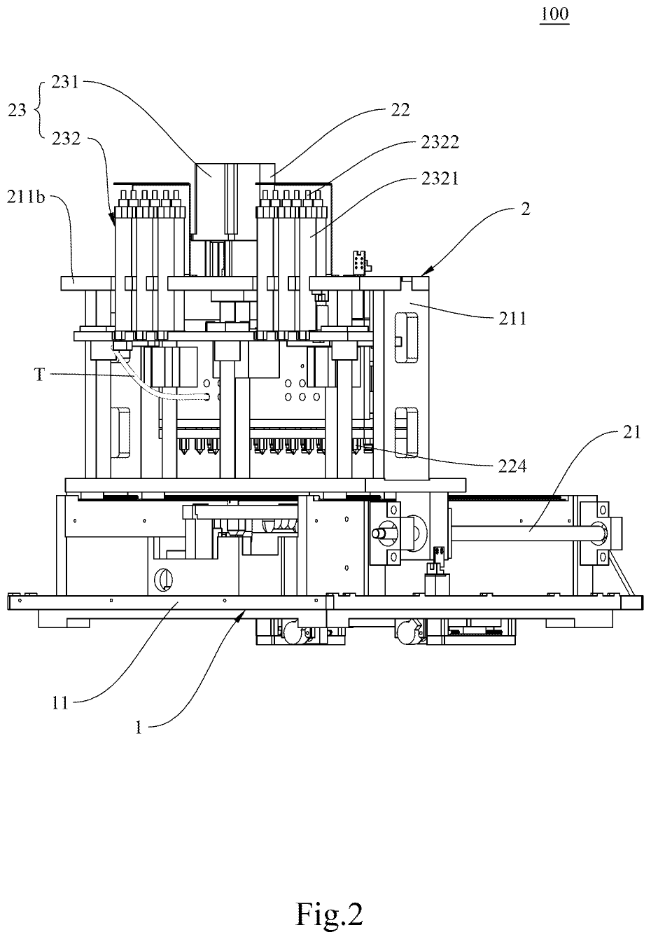

Please refer to FIG. 1 to FIG. 4 respectively for a perspective view and a rear-side structural diagram of the sample extraction device 100 according to a preferred embodiment of the present invention and a perspective view and a sectional view of the extraction table 1 of the sample extraction device 100.

As shown in FIG. 1 to FIG. 4, the present invention provides a sample extraction device 100, which includes the extraction table 1 and an operating and moving module 2, wherein the operating and moving module 2 can move, or displace, with respect to the extraction table 1. The extraction table 1 includes a base 11, a supporting structure 12, and a collection module 13. The base 11 has a receiving space 111. The supporting structure 12 is provided on the base 11. The collection module 13 is provided in the receiving space 111. The extraction table 1 may further include a heating module 14 according to practical needs. The operating and moving module 2 includes a first horizontal movement module 21, a first vertical movement module 22, and a suction module 23, wherein the suction module 23 is configured to generate positive or negative pressure when activated.

As used herein, the term “moving module” refers to an assembly of elements for effecting spatial displacement and may include hardware and/or software. In this embodiment, the moving modules include not only the operating and moving module 2, the first horizontal movement module 21, and the first vertical movement module 22, but also a second horizontal movement module 132 and a second vertical movement module 231 as described further below. A moving module may be integrated with such auxiliary elements as a power supply device, a motor, a control unit, a storage for receiving and storing commands, a positioning device, a data processor, and other related elements; the present invention has no limitation in this regard. The aforesaid other related elements include but are not limited to a communication unit, a power unit, and a display unit. The aforesaid software includes but is not limited to software for computing spatial positions and software for recording errors. The aforesaid auxiliary elements may further include a moving rail, a moving shaft, a shock absorbing unit, and so on.

As used herein, the term “sample” refers to substances requiring a mixture separation operation, such as a chemical sample, a food sample, or a biological sample. The present invention is particularly suitable for the extraction of hereditary substances such as nucleic acids, but has no limitation on the target substances to be extracted from a sample.

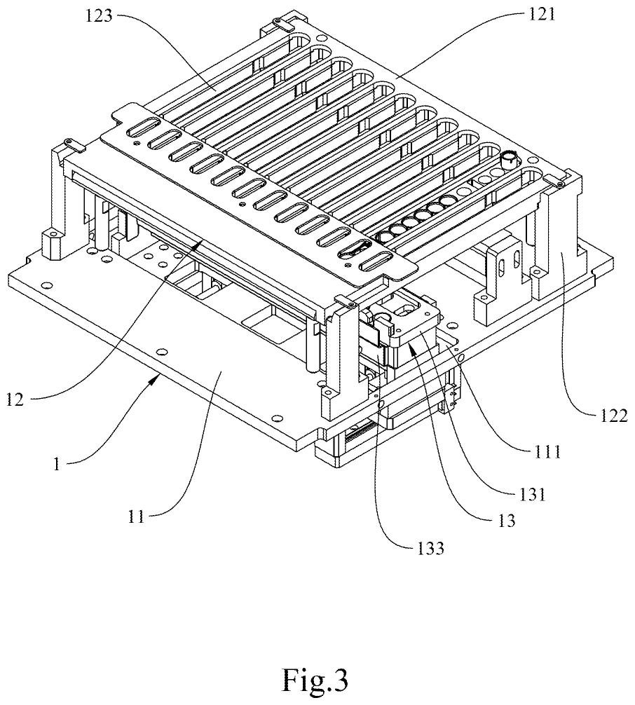

The supporting structure 12 includes a supporting table 121 and a fixing unit 122 for securing the supporting table 121 or on which the supporting table 121 is placed. The supporting table 121 includes a receptacle receiving space 123, wherein the receptacle may be configured to receive samples, reagents, spent liquor, or pipettes, for example. In a preferred embodiment, the receptacle receiving space 123 of the supporting table 121 includes a space for receiving a cartridge, wherein the cartridge is configured to receive, for example but not limited to, pipettes, binding columns, pipettes with an adapter, or reagents, and wherein the cartridge may be divided into a plurality of receiving spaces. This preferred embodiment is advantageous in that one sample may use a single cartridge to prevent cross-contamination between samples of different batches. Another advantage is that, each time an extraction operation is completed, the operator may directly replace the used cartridge with a new one to reduce the time and labor otherwise required for replacing different used containers. In a preferred embodiment, the supporting table 121 is provided above and corresponds to the receiving space 111 of the base 11 (see FIG. 3).

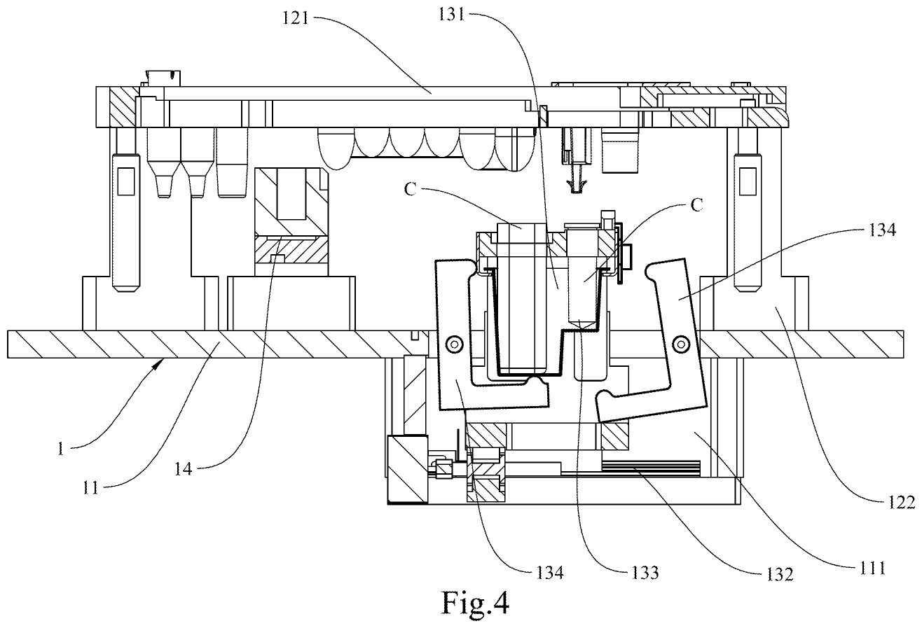

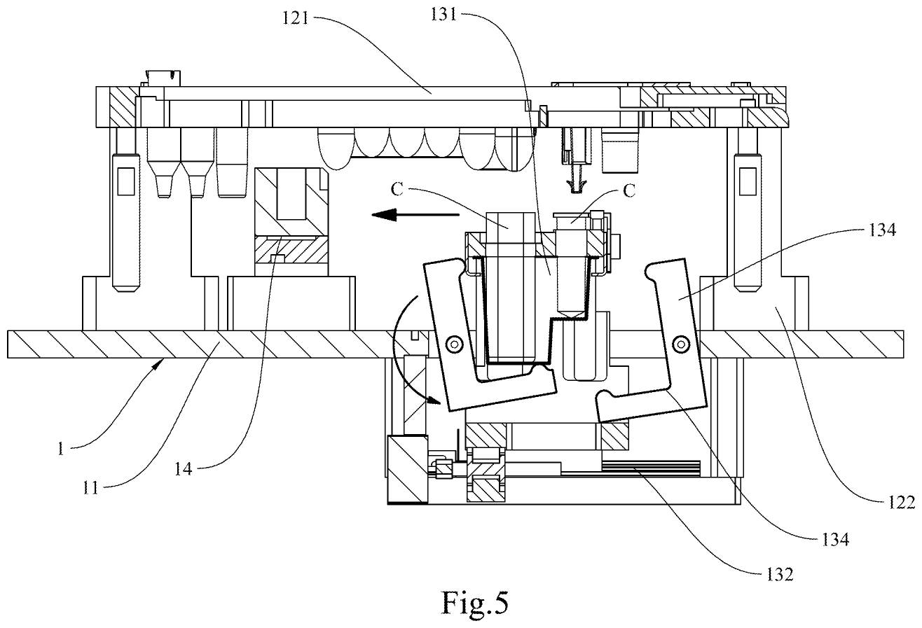

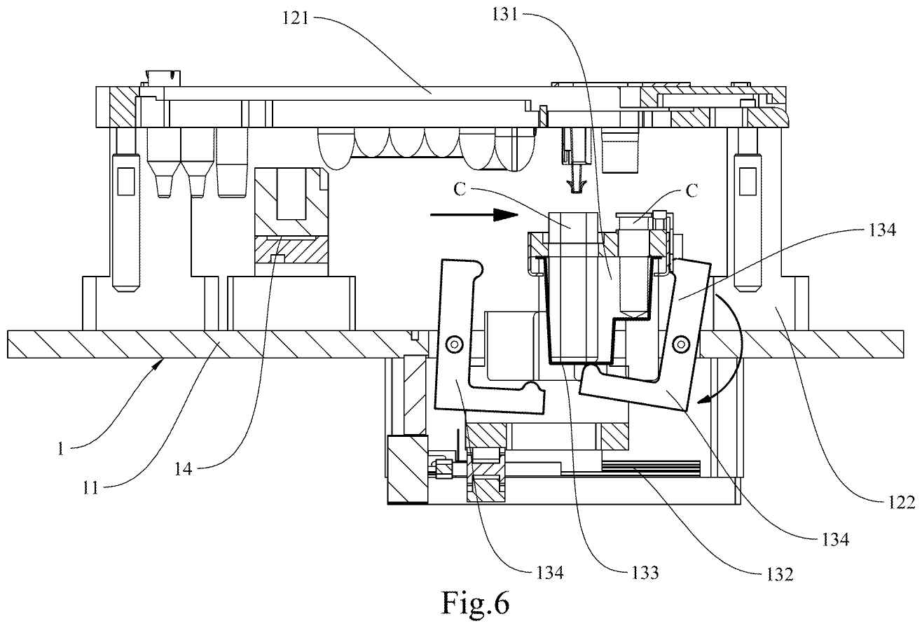

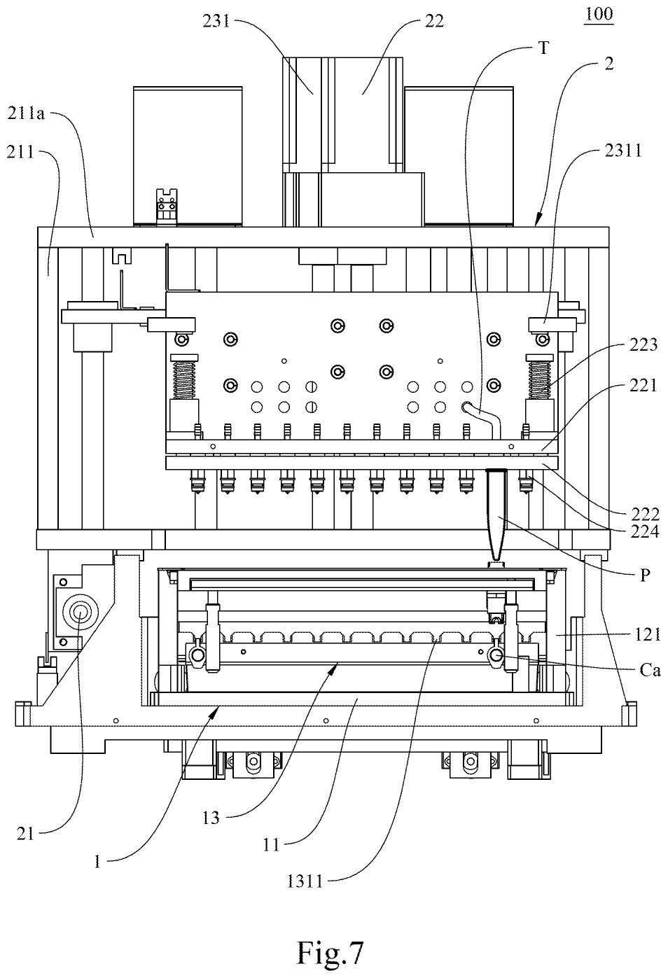

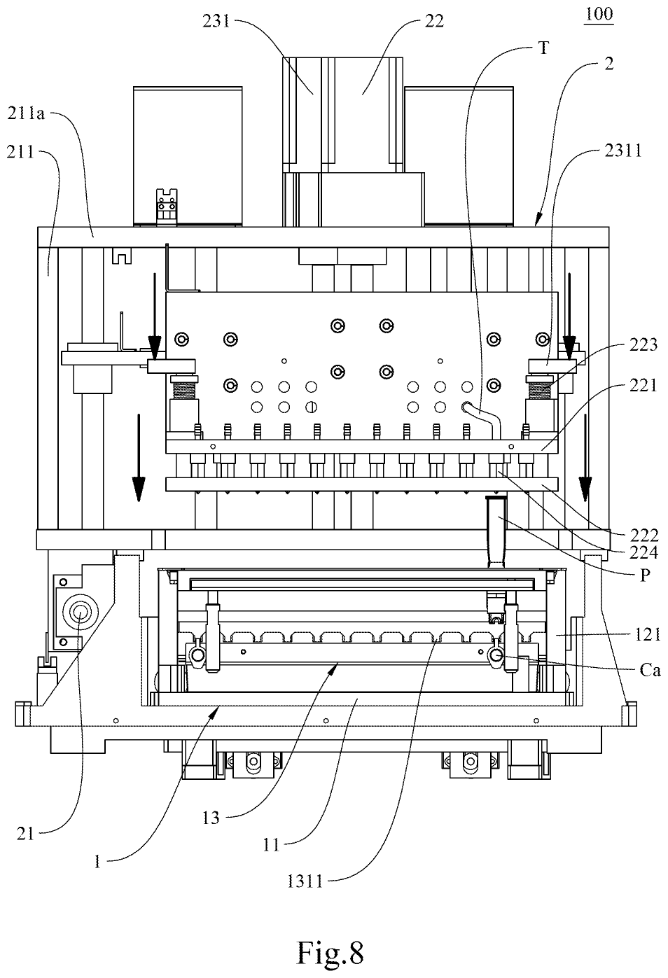

The collection module 13 includes a collection module base 131 for receiving containers C and may further include the aforementioned second horizontal movement module 132, a driven member 133, and a driving unit 134. The second horizontal movement module 132 is configured to move the collection module base 131 horizontally in the receiving space 111. The driven member 133 is mounted around a bottom portion of the collection module base 131. The driving unit 134 is provided in the receiving space 111 and in the vicinity of the collection module base 131. When the collection module base 131 is moved horizontally, referring to FIG. 5 and FIG. 6, the driving unit 134 is driven by the collection module base 131 and, in turn, pushes the driven member 133 mounted around the bottom portion of the collection module base 131; as a result, the collection module base 131 or the containers C in the collection module base 131 are moved by the driven member 133. In a preferred embodiment, the driven member 133 is made of a supportive material such as, but not limited to, a polymer, fibers, glass, ceramic, or a mixture of the above. In a preferred embodiment, the driven member 133 is made of a high molecular polymer (e.g., plastic) to offer such advantages as rapid production, low cost, and ease of mass production so that the driven member 133 can be replaced whenever necessary to avoid contamination resulting from repeated use. Containers C suitable for use in the collection module base 131 include but are not limited to centrifuge tubes (also referred to as Eppendorf tubes) for receiving the extracted target substances and spent liquor tanks for receiving used washing liquid. In a preferred embodiment, the containers C in the collection module base 131 correspond in position to the cartridge(s) in the supporting table 121 (see FIG. 4). For example, the collection module base 131 receives a centrifuge tube that corresponds in position to a binding column in a cartridge in the supporting table 121. The collection module base 131 may further include an engaging groove 1311 (see FIG. 7 and FIG. 8) for securing the lids Ca of the containers C, e.g., the lid Ca of a centrifuge tube C. This embodiment is advantageous in that the engaging groove 1311 can prevent trouble in use attributable to movement of the lids Ca. More specifically, once a container C (e.g., a centrifuge tube) is placed in the collection module base 131, the lid Ca of the container C may, if not secured in the engaging groove 1311, move due to movement or shaking of the sample extraction device 100 during operation and end up blocking an adjacent container C or other receiving groove or even if interfering with the operation of the entire device or spilling the sample in either container or the affected receiving groove. The second horizontal movement module 132 in the present invention is advantageous in that it only has to displace the collection module base 131 slightly and the driving unit 134 and the driven member 133 will be driven to displace the containers C in the collection module base 131 upward or downward. This allows the containers C to be lifted up in the target substance or spent liquor collection stage of an extraction operation so that the target substances or reagents will not splash due to the injection of a liquid and be cross-contaminated as a result.

The first horizontal movement module 21 is provided on the base 11 and includes a supporting frame 211. Preferably, the supporting frame 211 spans the base 11 and rests on two opposite ends of the base 11. The first horizontal movement module 21 is configured to move horizontally, e.g., transversely (or along the X-axis direction), longitudinally (or along the Y-axis direction), obliquely, or along a horizontal curved line; the present invention has no limitation on the direction of horizontal movement of the first horizontal movement module 21. The first horizontal movement module 21, therefore, can move horizontally with respect to the base 11 and hence with respect to the extraction table 1. In a preferred embodiment, the supporting frame 211 is vertical with respect to the base 11, can move horizontally in the space above the extraction table 1, and has a front side 211a and a rear side 211b opposite the front side 211a. In a preferred embodiment, the moving direction of the first horizontal movement module 21 corresponds to the orientation of the receptacle receiving space 123 of the supporting table 121; that is to say, the supporting frame 211 is configured to move horizontally in a direction corresponding to the direction in which a receptacle (e.g., a cartridge) is placed in the supporting table 121. For example, the cartridge is mounted in the supporting table 121 in the longitudinal direction, and the first horizontal movement module 21 is configured to move in the Y-axis direction with respect to the supporting table 121 so that the supporting frame 211 can be moved horizontally to a specific position in the receptacle (e.g., the cartridge) supported by the supporting table 121. The provision of the first horizontal movement module 21 offers the following advantage: the relative positions of the extraction table 1 and the operating and moving module 2 can be changed by displacement of the first horizontal movement module 21 alone (i.e., without having to move the extraction table 1) in order to enable various extraction operations. This advantageous feature improves the low utilization rate of the operation space of the conventional automated extraction devices, and because of that, the sample extraction device 100 of the present invention has a much smaller volume than its prior art counterparts and is suitable for use on a common laboratory bench. It should be understood, however, that the present invention is not limited to rendering the extraction table 1 (or objects thereon) immovable; for example, to further shorten the distance for which the first horizontal movement module 21 has to move, the supporting table 121 may have a moving module configured to be displaced with respect to the first horizontal movement module 21. In short, the present invention has no limitation on the movability of the extraction table 1.

The first vertical movement module 22 is provided on the supporting frame 211 and includes a first platform 221 provided with a micropipette holder 224. The micropipette holder 224 is configured to be provided with a micropipette P at one end and is provided with a gas delivery tube T at the other end. The micropipette holder 224 is hollow inside to enable communication between the gas delivery tube T and the micropipette P. In a preferred embodiment, the first vertical movement module 22 further includes a second platform 222 provided underneath the first platform 221, wherein the micropipette holder 224 on the first platform 221 extends through the second platform 222, and the first platform 221 is penetrated by a spring unit 223 that connects the first platform 221 to the second platform 222. The first vertical movement module 22 is configured for vertical movement and can therefore move vertically with respect to the extraction table 1; in other words, the first vertical movement module 22 can be displaced upward and downward with respect to the extraction table 1 and hence with respect to the receptacle receiving space 123 of the supporting table 121. Micropipettes P suitable for use in the present invention may have a capacity ranging from 0.1 to 5000 microliters (μL), such as 0.1 μL, 0.2 μL, 0.5 μL, 1 μL, 2 μL, 5 μL, 10 μL, 20 μL, 50 μL, 100 μL, 200 μL, 300 μL, 500 μL, 1000 μL, 2000 μL, or 5000 μL, preferably from 1 to 1000 μL; the foregoing ranges and values, however, are not limiting. The capacity of the micropipette P and the micropipette holder 224 corresponding to the micropipette P may be adjusted according to practical needs.

The suction module 23 is also provided on the supporting frame 211 and includes a moving module and an injector 232. The injector 232 has an airtight cylinder 2321 and a piston rod 2322 matching the airtight cylinder 2321. The front end of the airtight cylinder 2321 is formed with a hole. Liquid or gas can be discharged from the airtight cylinder 2321 by pushing the piston rod 2322 inward of the airtight cylinder 2321, and be drawn into the hole at the front end of the airtight cylinder 2321 by pulling the piston rod 2322 outward of the airtight cylinder 2321. Once the airtight cylinder 2321 is connected to the gas delivery tube T, therefore, the injector 232 enables the micropipette P which is indirectly connected with the other end of the gas delivery tube T to produce a discharging or sucking effect. The moving module is configured to be moved and thereby cause the injector 232 to generate positive or negative pressure. For example, the moving module can be moved to push or pull the airtight cylinder 2321 or the piston rod 2322 so that the injector 232 generates positive or negative pressure, and it follows that the moving module preferably corresponds in position to the injector 232. In a preferred embodiment where the injector 232 is provided vertically on the supporting frame 211, the moving module serves as the aforementioned second vertical movement module 231 and can move vertically with respect to the extraction table 1, and once the second vertical movement module 231 is activated, the airtight cylinder 2321 or the piston rod 2322 will be driven in order for the injector 232 to generate positive or negative pressure, and for the micropipette P at the other end of the gas delivery tube T to produce a discharging or sucking effect as a result. In a more preferred embodiment, the piston rod 2322 is fixed on the supporting frame 211, and the second vertical movement module 231 is configured to move the airtight cylinder 2321 vertically so that the injector 232 generates positive or negative pressure.

The second vertical movement module 231 may further include a pushing unit 2311. The pushing unit 2311 compresses the spring unit 223 when the second vertical movement module 231 has moved downward to a predetermined position, and the compressed spring unit 223 releases the mechanical energy stored therein by pushing the second platform 222, through which the micropipette holder 224 extends. Once displaced downward with respect to the micropipette holder 224, the second platform 222 disengages the micropipette P from the micropipette holder 224 (see FIG. 7 and FIG. 8). Thus, according to the present invention, the micropipette holder 224 can be moved to a desired position by simultaneous (or non-simultaneous) movement of the first horizontal movement module 21 and the first vertical movement module 22, then brought into engagement with a micropipette P pre-positioned in the supporting table 121 by vertical movement of the first platform 221, and eventually rid of the micropipette P by the pushing unit 2311 driving the second platform 222 indirectly into vertical movement. In a preferred embodiment, the first vertical movement module 22 is provided on the front side 211a of the supporting frame 211, with the suction module 23 provided on the rear side 211b of the supporting frame 211. Depending on practical needs, however, a person skilled in the art may adjust the locations of the first vertical movement module 22 and the second vertical movement module 231, alter the way the two vertical movement modules are provided, and/or design the two vertical movement modules in such a way that they are driven by the same moving module, provided that the two vertical movement modules can be moved vertically with respect to the base 11 and independently of each other. In short, the present invention has no limitation on where and how the first vertical movement module 22 and the second vertical movement module 231 should be provided.

In addition, as previously mentioned, the heating module 14 may be provided to facilitate adjustment and control of extraction conditions, if so desired. The heating module 14 is provided therein with a heating device, is provided on the base 11, and corresponds to the supporting structure 12. In a preferred embodiment, the heating module is provided therein with a heating device and a U-shaped channel (not shown), and the U-shaped channel is connected to two parallel holes. This embodiment is advantageous in that, when the heating device is in operation, the heating module produces a stack effect due to the U-shaped channel and the holes, allowing the air temperature in the heating module to rise with the vertical slope of the U-shaped channel, thereby inducing strong air convection to enhance heating efficiency effectively.

A preferred embodiment is described below to demonstrate how the present invention draws liquid into a micropipette and discharges the liquid from the micropipette afterward.

First, with the micropipette holder 224 engaged with a micropipette P, the supporting frame 211 of the first horizontal movement module 21 is moved to a proper position. Then, the first platform 221 of the first vertical movement module 22 is moved downward until the micropipette P contacts the sample or reagent in the receptacle in the supporting table 121. After that, the second vertical movement module 231 moves downward and thereby pulls the airtight cylinder 2321 or the piston rod 2322, in order for the injector 232 to generate negative pressure, and consequently for the micropipette P, which is in communication with the injector 232 through the gas delivery tube T, to also generate negative pressure and thereby draw in the sample or reagent. The internal pressure of the injector 232 can be adjusted according to the amount of liquid to be drawn.

Then, with the micropipette P holding the sample or reagent, the first vertical movement module 22 moves upward until the supporting frame 211 reaches another proper position. After that, the first platform 221 of the first vertical movement module 22 is moved downward again, and the second vertical movement module 231 pushes the airtight cylinder 2321 or the piston rod 2322 by moving upward, in order for the injector 232 to generate positive pressure, and consequently for the micropipette P to generate positive pressure too and thereby discharge the sample or reagent. The amount discharged from the micropipette P can be controlled by fine-tuning the internal pressure of the injector 232, i.e., by controlling the displacement of the second vertical movement module 231. It is also feasible to move the second vertical movement module 231 upward and downward by turns so that the injector 232 and the micropipette P generate positive pressure and negative pressure alternately. This operation enables the micropipette P to produce a mixing effect by drawing in and discharging liquid repeatedly.

As above, the present invention provides a sample extraction device whose operating and moving module can move horizontally and vertically with respect to the extraction table so that the sample extraction process can be carried out by displacing the operating and moving module only, without moving the extraction table. This substantially reduces the space required for operation, making the sample extraction device of the present invention suitable for use on a laboratory bench. The second horizontal movement module in the present invention can move the driving unit and the driven member by slightly displaced the collection module base, thereby displacing the containers in the collection module base vertically. This allows the containers to move upward in the target substance collection stage and/or the spent liquor collection stage of an extraction operation, lest the target substances or reagents splash due to the ejection of a liquid and be cross-contaminated as a result. Furthermore, the engaging groove of the collection module base is configured to secure the lids of the aforesaid containers (e.g., centrifuge tubes) so that extraction operations will not be affected by displacement of the containers or rotation of the lids (the lids may block the operation area if not so secured). Thus, the sample extraction device of the present invention can effectively increase the extraction efficiency of target substances (e.g., nucleic acids) and provide consistent extraction quality.

The present invention is more detailed illustrated by the above preferable example embodiments. While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A sample extraction device, comprising:
an extraction table comprising:
a base having a receiving space;
a supporting structure provided on the base, wherein the supporting structure comprises a supporting table and a fixing unit on which the supporting table is placed, the supporting table is provided above and corresponds to the receiving space, and the supporting table comprises a receptacle receiving space; and
a collection module provided in the receiving space, wherein the collection module comprises a collection module base for receiving a container; and
an operating and moving module comprising:
a first horizontal movement module provided on the base and configured to move horizontally with respect to the extraction table, wherein the first horizontal movement module comprises a supporting frame;
a first vertical movement module provided on the supporting frame and configured to move vertically with respect to the extraction table, wherein the first vertical movement module comprises a first platform and a second platform provided underneath the first platform, the first platform is penetrated by a spring unit and is connected to the second platform via the spring unit, the first platform is provided with a micropipette holder extending through the second platform, and the micropipette holder has an end which is used for configuring with a micropipette and an opposite end provided with a gas delivery tube; and
a suction module provided on the supporting frame, wherein the suction module comprises a second vertical movement module and an injector, the second vertical movement module is configured to move vertically with respect to the extraction table, the injector has an airtight cylinder and a piston rod, and the airtight cylinder is connected to the gas delivery tube;
wherein the second vertical movement module moves vertically to push or pull the airtight cylinder or the piston rod, in order for the injector to generate positive or negative pressure.

2. The sample extraction device of claim 1, wherein the collection module comprises:
a second horizontal movement module configured to move the collection module base horizontally in the receiving space;
a driven member mounted around a bottom portion of the collection module base; and
a driving unit provided in the receiving space and in the vicinity of the collection module base;
wherein the driving unit moves by the collection module base moving and, in turn, the driving unit pushes the driven member so as to move the collection module base or the containers received in the collection module base.

3. The sample extraction device of claim 2, wherein the collection module base comprises an engaging groove for securing a lid of the container.

4. The sample extraction device of claim 1, wherein the extraction table comprises a heating module provided on the base, and corresponds to the supporting structure.

5. The sample extraction device of claim 1, wherein the second vertical movement module comprises a pushing unit for compressing the spring unit when the second vertical movement module moves downward, in order for the compressed spring unit to move the second platform, and for the micropipette to be removed from the micropipette holder when the second platform, through which the micropipette holder extends, is displaced downward with respect to the micropipette holder.

6. The sample extraction device of claim 3, wherein the receptacle receiving space of the supporting table comprises a space for receiving a cartridge, wherein the cartridge is configured to receive pipettes, binding columns, pipettes with an adapter, or reagents.

7. The sample extraction device of claim 6, wherein the containers in the collection module base correspond in position to the cartridge(s) in the supporting table.

8. The sample extraction device of claim 7, wherein the moving direction of the first horizontal movement module corresponds to the orientation of the receptacle receiving space of the supporting table.

9. The sample extraction device of claim 1, wherein the supporting frame is vertical with respect to the base and has a front side and a rear side opposite the front side; and the first vertical movement module is provided on the front side of the supporting frame, with the suction module provided on the rear side of the supporting frame.

10. The sample extraction device of claim 1, wherein the piston rod is fixed on the supporting frame, and the second vertical movement module is configured to move the airtight cylinder vertically so that the injector generates positive or negative pressure.
